(19) United States
(12) Patent Application Publication
(10) Pub. No.: US 2005/0244167 A1
(43) Pub. Date: Nov. 3, 2005

(54) Signal-to-noise ratio (SNR) value characterization in a data recovery channel

(76) Inventors: Sanyuan Liew, Singapore (SG); TeckKhoon Lim, Singapore (SG); CheeFong Oh, Singapore (SG); WengKhin Chew, Singapore (SG); KokHoe Chia, Singapore (SG); SongWee Teo, Singapore (SG)

Correspondence Address: Seagate Technology LLC, 1280 Disc Drive, Shakopee, MN, 55379, US

(21) Appl. No.: 10/834,480

(22) Filed: Apr. 29, 2004

(51) Int. Cl. H04B 10/06

(52) U.S. Cl. 398/202

(57) ABSTRACT

Method and apparatus for determining a signal-to-noise ratio (SNR) value from a readback signal, such as in a data storage device. A readback signal is obtained by a receiver (such as a data transducing head) coupled to a data recovery channel having a variable gain amplifier (VGA) and a threshold detector (TD). The data channel applies a selectable VGA gain value to the readback signal while errors are accumulated using a selectable error detection threshold from the TD. The SNR value is determined at least from a magnitude of the error detection threshold, and preferably from first and second VGA gain values using a linear regression model. The determined SNR value is highly correlated to classical SNR values obtained using external equipment such as an analyzer or oscilloscope, and is advantageously used in automated fashion during high volume manufacturing certification testing.

### FIELD OF THE INVENTION

The claimed invention relates generally to the field of data transmission systems and more particularly, but not by way of limitation, to an apparatus and method for characterizing a signal-to-noise ratio (SNR) for devices which employ a data recovery channel.

### BACKGROUND

Signal-to-noise ratio (SNR) is a well known metric used to adjudge the quality of a data transmission system. SNR can be defined as a ratio of signal power to noise power in a readback (received) signal. Generally, the higher the SNR value, the lower the amount of noise in the signal, making it easier to decode the transmitted information from the signal.

When evaluating data storage devices in a manufacturing environment, it is desirable to test the individual devices in such a way as to be able to predict how well (or poorly) the devices will operate during subsequent field use. Devices that pass the testing process are shipped, while failed devices are rejected and reworked or scrapped.

SNR is a useful metric in predicting long term device operational performance. However, direct measurement of SNR values at the device level has not been widely carried out in high volume manufacturing environments due to the equipment and labor intensive effort required (e.g., hooking up special test equipment such as analyzers and oscilloscopes, capturing the necessary information from a readback signal to calculate an SNR value, etc.).

Instead, device manufacturers have tended to rely on other, easier to obtain metrics such as bit error rate (BER) to evaluate device performance. As will be recognized, BER generally comprises a measure of how many erroneous bits are received out of a large total population of transmitted bits. A BER value can be readily obtained by instructing a particular device to record a particular pattern and re-read the pattern a number of times while counting the occurrence of errors.

While devices with low BER tend to also have low SNR values, it has been found from time to time that devices with unacceptably low SNR values can nevertheless escape the BER testing process. One reason may be the interaction between different components; for example, a particular magneto-resistive (MR) head in a device may be marginally noisy, but the communication electronics or media may be strong enough to mask this condition during a BER test.

SNR values are also useful in evaluating new designs. For example, along with various other characteristics including recording transition width, head flying height, and head recording width (PW50), SNR is a significant limiting factor in determining the maximum recording density that can be achieved for a recording medium in a particular design.

Accordingly, with the continued demand for high performance data recovery channels such as utilized in data storage devices, there remains a continued need for improvements in the manner in which SNR values can be obtained. It is to such improvements that the claimed invention is generally directed.

### SUMMARY OF THE INVENTION

In accordance with preferred embodiments, a method and an apparatus are provided for determining a signal -to-noise ratio (SNR) value from a readback signal, such as in a data storage device.

Preferably, a readback signal is obtained by a receiver (such as a data transducing head) coupled to a data recovery channel having a variable gain amplifier (VGA) and a threshold detector (TD). The data channel applies a selectable VGA gain value to the readback signal while errors are accumulated using a selectable error detection threshold from the TD.

The SNR value is determined at least from a magnitude of the error detection threshold, and preferably from first and second VGA gain values as well in accordance with a linear regression model.

The determined SNR value is highly correlated to classical SNR values obtained using external equipment such as an analyzer or oscilloscope, and is advantageously used in automated fashion during high volume manufacturing certification testing.

These and various other features and advantages which characterize the claimed invention will become apparent upon reading the following detailed description and upon reviewing the associated drawings.

### BRIEF DESCRIPTION OF THE DRAWINGS

FIG. 1 is an exploded perspective view of a data storage device constructed and operated in accordance with preferred embodiments of the present invention.

FIG. 2 is a functional block diagram of a magnetic communication (readback) channel of the device of FIG. 1.

FIG. 3 is a graphical representation of a readback signal processed by the channel of FIG. 2.

FIG. 4 is a flow chart for an SNR DETERMINATION routine, illustrative of steps carried out in accordance with preferred embodiments to characterize a signal-to-noise (SNR) value for the device of FIG. 1.

FIG. 5 is a graphical representation of a 2T pattern written during the routine of FIG. 4.

FIG. 6 is a graphical representation of a first readback signal obtained from the 2T pattern during the routine of FIG. 4.

FIG. 7 is a graphical representation of a second readback signal obtained from the 2T pattern during the routine of FIG. 4.

FIG. 8 is a graphical representation of a third readback signal obtained from the 2T pattern during the routine of FIG. 4.

### DETAILED DESCRIPTION

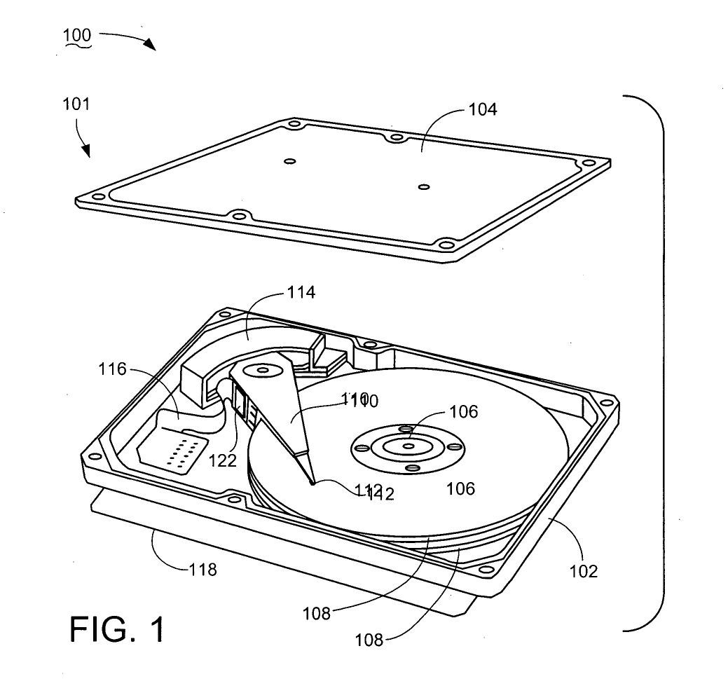

While the claimed invention has utility in any number of different applications, FIG. 1 has been provided to illustrate a particularly suitable environment in which the claimed invention can be advantageously practiced.

FIG. 1 shows an exploded, perspective top plan representation of a data storage device 100 of the type used to magnetically store and retrieve computerized user data. The device 100 includes a sealable housing 101 formed from a base deck 102 and a top cover 104.

A spindle motor 106 rotates a number of data recording discs 108 (in this case, two) at a constant high speed. A rotary actuator 110 suspends a corresponding array of data transducing heads 112 adjacent the disc surfaces. The heads 112 (also referred to herein as “receivers” or “transducers”) are moved across the radii of the discs 108 through application of current to a voice coil motor, VCM 114. The VCM 114 aligns the heads 112 with tracks (not shown) defined on the disc surfaces to write data to and read data from the discs 108.

A flex circuit assembly 116 provides a communication path between the actuator 110 and control electronics on a printed circuit board assembly (PCBA) 118. The PCBA 118 is mounted to the underside of the base deck 102, as shown.

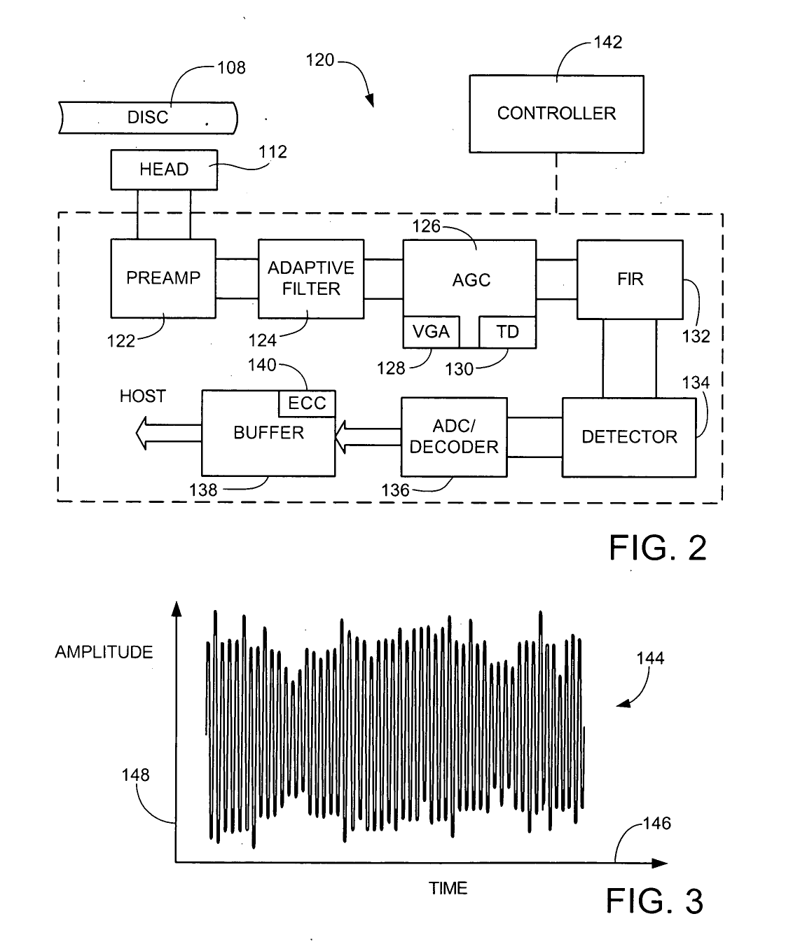

FIG. 2 provides a generalized functional block diagram of a data communication (readback) channel 120 of the data storage device 100 in accordance with preferred embodiments. Previously recorded data are transduced from the selected disc 108 by the associated head 112 to provide a readback signal to a preamplifier/driver circuit (preamp) 122. The preamp 122 is attached to a side of the actuator 110, as shown in FIG. 1.

The preamp 122 provides a preamplified signal to an adaptive filter 124, which applies low pass filtering to remove high frequency noise. The filtered readback signal is provided to an automatic gain control (AGC) circuit 126. During normal operation, the AGC circuit 126 operates to adaptively adjust the peak-to-peak signal amplitude of the input readback signal to a normalized range suitable for subsequent processing by remaining portions of the channel 120.

The AGC circuit 126 includes a variable gain amplifier (VGA) 128 which applies a VGA gain value to the signal to adjust the peak-to-peak amplitude. The AGC circuit 126 further includes a threshold detector (TD) 130 which operates as a peak detection circuit to detect peaks within the signal.

The normalized readback signal from the AGC circuit 126 is supplied to an finite impulse response (FIR) circuit 132, which operates to filter the signal to a selected class of partial response, maximum likelihood (PRML) responses (in this case, PR-IV). A Viterbi detector 134 samples the filtered response to provide estimates of the original bit sequence from the readback signal.

An analog-to-digital converter (ADC) and decoder circuit 136 decodes the recovered sequence to output the originally stored data (in multi-bit digital form) to a buffer 138. An error correction code (ECC) block 140 performs on-the-fly error detection and correction and, if no errors remain in the data, the data are transferred to the host device. The channel operation is controlled by a top level controller 142, preferably comprising a programmable processor with suitable programming.

FIG. 3 provides a generalized representation of a readback signal 144 received and processed by the channel 120 of FIG. 2. The signal 144 is plotted against an elapsed time x-axis 146 and an amplitude (volts) y-axis 148, and comprises a series of positive and negative peaks which generally correspond to magnetic flux reversals (transitions) on the associated disc 108. While ideally the signal would have a substantially uniform peak-to-peak amplitude range, those skilled in the art will recognize that various factors tend to both induce larger signal strengths and regions of floating noise with reduced peak amplitudes. A number of factors such as noise introduced by the head 112, the media 108 and the channel electronics (FIG. 2) can contribute to the readback signal having characteristics as generally represented in FIG. 3.

Signal-to-noise ratio (SNR) is a measure of signal intensity to noise intensity. An SNR value can be calculated for a readback signal such as in FIG. 3 using, for example, an oscilloscope or similar equipment to measure the average zero-to-peak signal voltage (V₀) and a root-mean-squared (RMS) noise voltage (V_{N}), and then applying these values to the following formula:

$$SNR ( db ) = 10 log \frac{{V}_{0}^{2}}{{V}_{N}^{2}} = 20 log \frac{{V}_{0}}{{V}_{N}} \qquad ( 1 )$$

where (db) indicates decibels. While such an SNR value serves as a useful measure to predict real-world performance of the device 100 during customer use, it is generally impractical to carry out the foregoing technique in a manufacturing test environment.

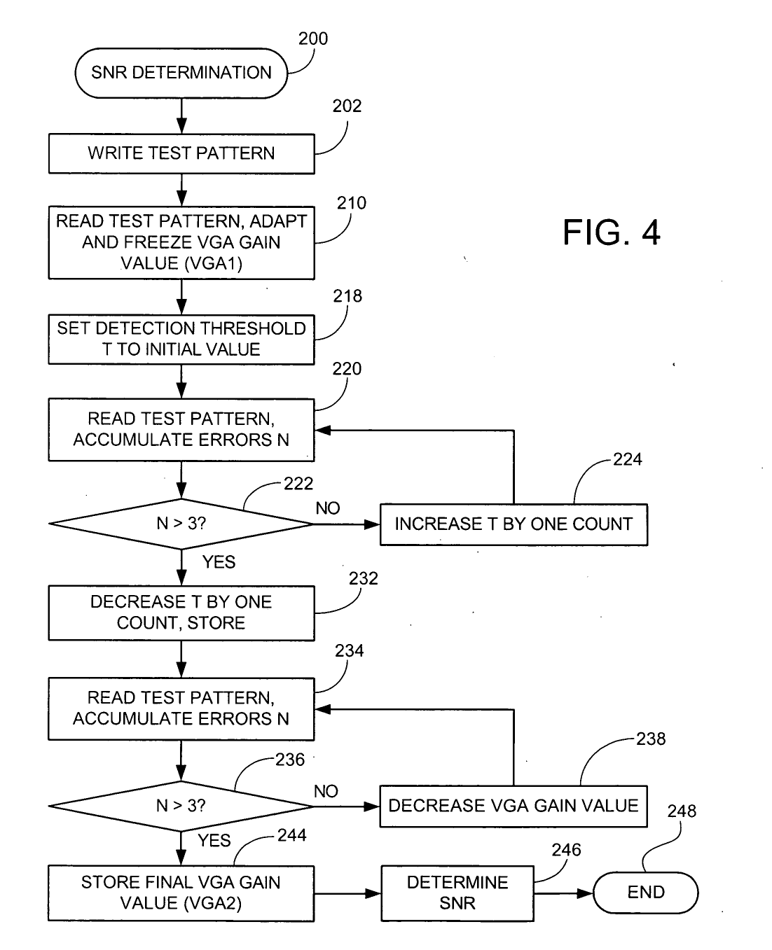

Accordingly, FIG. 4 provides a flow chart for an SNR DETERMINATION routine 200. The routine 200 generally illustrates steps carried out by the channel 120 under the direction of the controller 142 (FIG. 2) to determine an SNR value for each selected head/media combination. The routine 200 is carried out without the need for external equipment and human intervention, and the resulting SNR value is highly correlated to a measured SNR value obtained in accordance with equation (1).

The routine 200 uses a linear regression model obtained using conventional regression analysis techniques. The model preferably takes the following form:
SNR(db)=A(T)+B(VGA1)+C(VGA2)+D (2)
where T is an error detection threshold obtained by the threshold detector 130 (FIG. 2) and VGA1, VGA2 are different gain values obtained by the VGA 128 during the routine 200. The values A, B, C, and D are constants. While the particular values of A, B, C and D will depend upon the configuration of a given device, for reference a particular model provided values of A=(0.895), B=(0.0787), C=(−0.840) and D=(5.890). Additional details with regard to the regression model will be discussed below.

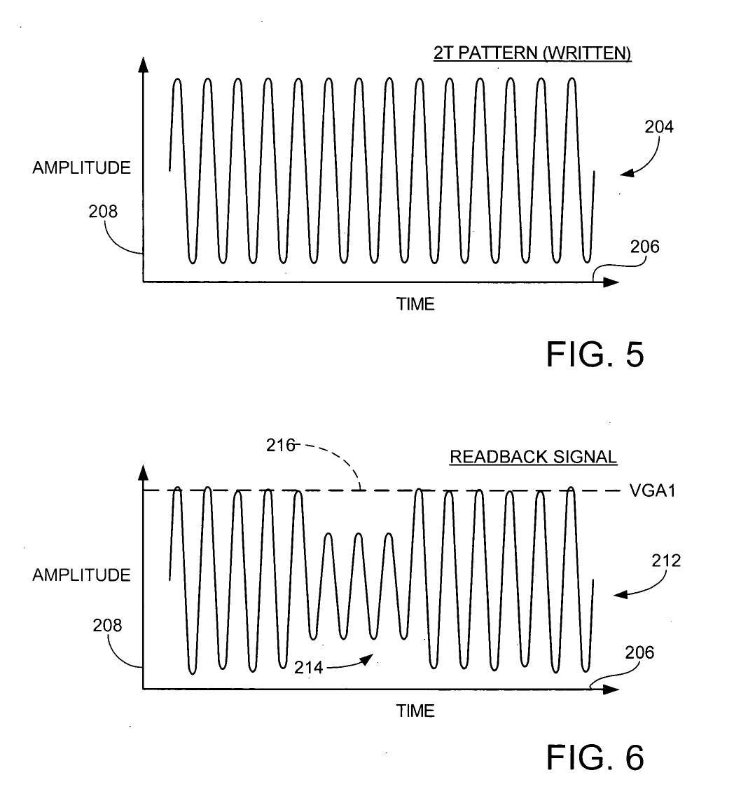

Referring now to the routine 200 of FIG. 4, a suitable test pattern is first written to a selected one of the discs 108 at step 202. Preferably, a DC erase operation is carried out to erase a small band of adjacent tracks on the disc 108 (such as seven tracks) and an oscillating 2T pattern is written to the middle track within this band. This 2T pattern is graphically represented at 204 in FIG. 5, plotted against an elapsed time x-axis 206 and an amplitude y-axis 208. It will be noted that the 2T pattern 204 nominally has a constant amplitude and frequency, and is preferably written to all of the available user data areas on the selected track.

Since MR heads (such as 112) tend to have a higher fly height near the outermost diameter (OD) of a disc, the pattern 204 is preferably written near the OD of the associated disc 108. However, other suitable locations on the disc surface can be used. Indeed, as desired the entire routine 200 can be repeated a number of times at different radii across the same disc surface, such as in each zone of tracks in devices employing zone based recording, ZBR.

Preferably, step 202 involves other preliminary operations as well, including the temporary deactivation of ECC and error retry routines by the controller 142, and activation of a defect scan mode.

At step 210, the device 100 operates to continuously read the 2T pattern written during step 202 to adapt the VGA gain. During step 210, a readback signal will be obtained such as represented at 212 in FIG. 6. The readback signal 212 will not typically be a perfect replication of the written signal, but will instead have some variations due to noise and other factors, as shown.

More specifically, the readback signal 212 may sporadically include floating noise regions with locally weaker signal amplitudes, such as generally depicted at 214 in FIG. 6. Such regions may or may not be repeatable over each revolution, but will generally tend to reappear in the signal at a regular rate. Those skilled in the art will recognize that other noise manifestations may be present as well such as high frequency spikes and baseline shifts, but it is contemplated that such will be largely removed or reduced by the operation of the preamp 122 and filter 124, and thus have not been shown for clarity of discussion.

While the readback signal 212 is acquired over a number of disc revolutions, the gain of the VGA 128 (FIG. 2) will substantially converge to a steady state value, as depicted by broken line 216 in FIG. 6. This value is referenced above as the VGA1 value in equation (2) and is temporarily fixed so that the VGA 128 continues to apply this value during subsequent operation.

At step 218, a detection threshold of the threshold detector 130 (FIG. 2) is set to an initial value. This initial value is preferably a mid-range value low enough such that all of the peaks of the readback signal rise above this value. It will be noted that, preferably, the threshold is mirrored (i.e., two thresholds are applied, one on each side of the baseline value) so as to detect both positive going and negative going peaks, but only the positive peaks will be considered in the present discussion for simplicity.

At step 220, the device 100 proceeds with reading the test pattern and accumulates the number of errors, N, that are obtained for a given number of revolutions (such as five or 10). If N is less than a selected error occurrence value (such as 3), as shown by decision step 218, the flow continues to step 224 wherein the controller 142 increases the value of the threshold T by one count and the process is repeated.

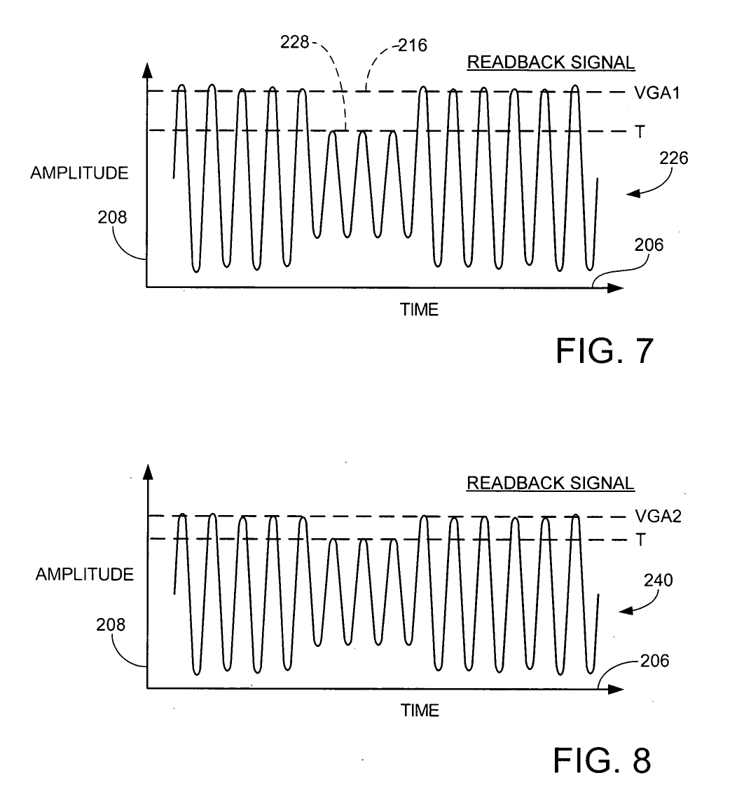

At some point the threshold T will have increased sufficiently such that N is greater than the selected error occurrence value of decision step 222, as shown by readback signal 226 in FIG. 7. Broken line 228 in FIG. 7 generally represents the error detection threshold T at the point where a floating noise region 230 no longer crosses over the threshold. The reduced amplitude pulses from the region 230 are counted toward the accumulated error total N. The operation of steps 220, 222 and 224 thus provides an indication of the noise occurrence level within the readback signal 228, that is, the extent to which noise is contributing to a reduction in signal strength.

Accordingly, the flow of FIG. 4 continues from decision step 222 to step 232 wherein the error detection threshold T is decreased by one count and stored. It will be noted that the threshold value T stored during step 232 is the largest threshold value that provided a total number of accumulated errors less than the error occurrence value (decision step 222). It will further be noted that the threshold value T stored during step 232 corresponds to the value T in equation (2) above.

At step 234, the process again resumes reading of the test pattern for a given number of revolutions and accumulating an error count N using the threshold value T from step 232. As before, the number of accumulated errors is compared to a selected error occurrence value, as denoted by decision step 236. While decision step 236 also uses a value of 3, other suitable values can be used as desired.

If the accumulated number of errors N is less than this value, the flow passes from decision step 236 to step 238 wherein the controller instructs the VGA 128 (FIG. 2) to decrease the applied gain by a selected increment, thereby reducing the overall peak-to-peak amplitude of the readback signal.

It has been observed that, generally, the amplitude reduction in otherwise “clean” peaks in a readback signal will tend to be reduced by a reduction in the VGA value at a higher rate than that of the reduced noise region; in other words, the signal peaks will tend to converge into the “grass” of the noisy region as VGA gain is reduced. Contrawise, the signal peaks will tend to “grow” out of the “grass” of the noisy region as VGA gain is increased.

As the VGA gain value is successively decreased by steps 234, 236 and 238, there will come a point at which the total accumulated number of errors N will exceed the error count value of decision step 236. This is graphically illustrated in FIG. 8 by readback signal 240. In FIG. 8, the final VGA gain value is denoted as VGA2 and is represented by broken line 242 in FIG. 8. This lower VGA2 gain value provides an understanding of the defect noise level and also appears in equation (2) above.

The VGA2 value is stored at step 244. At step 246, the routine determines an SNR value using the factors T, VGA1 and VGA2 and equation (2). The value can be calculated directly by the controller 142 (FIG. 2), or the T, VGA1 and VGA2 values can be output to the host device (such as via a command bus, not shown) and the host device can carry out this calculation, as desired.

Step 246 can further include the comparison of the determined SNR value to a baseline (pass/fail) SNR value (such as calculated in accordance with equation (1)) to output a pass/fail indication, as desired. This is particularly useful during a high volume manufacturing environment so that the routine 200 is part of a manufacturing certification test. The routine is shown to end at step 248, but it will be understood that the process can be repeated for additional head/media combinations within the same device.

As mentioned above, the particular regression model used will depend on a given device configuration. Table I provides details with regard to the regression modeling used to arrive at the factors used in equation (2):

TABLE I

| Predictor | Coef | SE Coef | T | P |
|---|---|---|---|---|
| Constant | 5.892 | 1.556 | 3.79 | 0.002 |
| Thresh (T) | 0.8952 | 0.1180 | 7.59 | 0.000 |
| VGA1 | 0.07875 | 0.02493 | 3.16 | 0.006 |
| VGA2 | 0.08405 | 0.02352 | −3.57 | 0.003 |

| | | |
|---|---|---|
| S = 0.2722 | R-Sq = 91.0% | R-Sq(adj) = 89.3% |

Analysis of Variance

| Source | DF | SS | MS | F | P |
|---|---|---|---|---|---|
| Regression | 3 | 11.9399 | 3.9800 | 53.73 | 0.000 |
| Residual Err | 16 | 1.1852 | 0.0741 | | |
| Total | 19 | 13.1251 | | | |

| Source | DF | Seq SS |
|---|---|---|
| Thresh (T) | 1 | 9.5698 |
| VGA1 | 1 | 1.4245 |
| VGA2 | 1 | 0.9456 |

Those skilled in the art will recognize that the R−Sq value of 91% shows that the three factors T, VGA1 and VGA2 are highly correlated to the measured SNR value. The p value of 0.000 is less than 0.05, meaning that the transfer function is significant.

Table II below provides data obtained for 20 devices nominally identical to the device 100 in FIG. 1:

TABLE II

| Device | SNR1 | SNR2 | T | VGA1 | VGA2 | Δ |
|---|---|---|---|---|---|---|
| 1 | 15.15 | 15.19 | A | 6C | 61 | 0.04 |
| 2 | 14.56 | 14.77 | A | 7D | 76 | 0.21 |
| 3 | 14.30 | 14.32 | A | 91 | 8E | 0.02 |
| 4 | 14.24 | 14.24 | A | B0 | AC | 0.00 |
| 5 | 15.80 | 15.66 | B | 7E | 77 | −0.14 |
| 6 | 14.36 | 14.32 | A | B2 | AD | −0.04 |
| 7 | 16.09 | 16.59 | C | 47 | 43 | 0.50 |
| 8 | 15.10 | 14.97 | A | 77 | 6E | −0.13 |
| 9 | 16.10 | 15.72 | B | 53 | 4E | −0.38 |
| 10 | 16.16 | 15.95 | B | 37 | 31 | −0.21 |
| 11 | 14.13 | 14.12 | A | 98 | 97 | −0.01 |
| 12 | 15.20 | 15.00 | B | 9B | 9A | −0.20 |
| 13 | 16.07 | 16.23 | C | 6C | 6A | 0.16 |
| 14 | 15.13 | 15.28 | B | 75 | 73 | 0.15 |
| 15 | 13.72 | 13.93 | 9 | 81 | 79 | 0.21 |
| 16 | 14.91 | 14.48 | A | A3 | 9D | −0.43 |
| 17 | 14.14 | 14.31 | A | A4 | A0 | 0.17 |
| 18 | 13.72 | 14.08 | A | 9F | 9E | 0.36 |
| 19 | 15.55 | 15.13 | B | 72 | 72 | −0.42 |
| 20 | 15.87 | 15.93 | B | 79 | 6F | 0.06 |

In Table II, “Device” refers to the devices 1-20 under consideration. “SNR1” is the measured SNR value obtained using the classical technique of equation (1). “SNR2” is the determined SNR value obtained using the routine 200 of FIG. 4 and equation (2). “T” is the threshold value (in hexadecimal) obtained during the operation of the routine 200. “VGA1” and “VGA2” are the respective VGA gain values (in hexadecimal) obtained during the operation of the routine 200. Delta “Δ” is the difference between the SNR1 and SNR2 values (i.e., Δ=SNR2−SNR1).

The low delta Δ values (ranging from about −0.4 to +0.5) confirm the high correlation between the routine of FIG. 4 and the measured SNR values of equation (1).

While the preferred approach discussed above uses the T, VGA1 and VGA2 values in the regression model, it will be appreciated that such is not necessarily limiting to the scope of the claimed invention. Rather, depending upon the requirements of a given application other combinations of factors may be used.

For example, the above analysis shows that generally, there is a relatively high degree of dependence between VGA1 and VGA2 values. Thus, while the following model may not provide the same degree of correlation, it is contemplated that in other embodiments a regression model may be provided in the general form of:
SNR(db)=E(T)+F(VGA)+G (3)
Where SNR is the determined SNR value (in decibels), T is the threshold value obtained during the routine of FIG. 4, and VGA is one of the VGA values (VGA1 or VGA2) obtained during the routine of FIG. 4. E, F and G are constants determined using a regression analysis as set forth by Table I. It is contemplated that situations may arise where the model as set forth by equation (3) provides adequate results.

Moreover, as indicated by the analysis results of Table I, and as confirmed by additional analysis of the results, the largest contributor in determining correlation with the measured SNR value of equation (1) is the threshold value (T). Thus, it is further contemplated that in other embodiments a regression model may be provided in the general form of:
SNR(db)=H(T)+I (4)
where SNR is the determined SNR value (in decibels), T is the threshold value obtained at the baseline (VGA1) value, and H and I are constants. Again, the results of the model of equation (4) may be found to provide adequate correlation to the measured SNR values of equation (1). Finally, it will be noted that investigation may reveal other factors (e.g., adaptive parameters used by the adaptive filter 124, tap weights of the FIR 132, etc.) that may be additionally incorporated into the model, as the circumstances dictate.

It will now be appreciated that the routine 200 of FIG. 4 provides advantages over the prior art. A device level SNR value can be readily determined easily and efficiently without the need for the use of external hardware and equipment (e.g., analyzers, oscilloscopes, etc.) and human intervention to obtain the data necessary to calculate the SNR value.

The routine can be readily incorporated as part of a device certification test during manufacturing processing, and can be used in lieu of or in addition to standard tests (BER, etc.) to characterize operational performance of the devices. The routine 200 can further be used during failure analysis efforts to investigate and apply corrective action to failure events, and can also be used during design efforts to arrive at device configurations (e.g., areal densities, recording frequencies, etc.).

While linear regression modeling is the preferred approach to arriving at the SNR determination model, it will be recognized that such is not limiting; that is, other models (including higher order models) using at least the error detection threshold T can readily be used as well to determine the SNR value. Moreover, while the foregoing preferred embodiments utilize a readback signal transduced from a recording medium, the routine of FIG. 4 can readily be utilized for other received readback signals.

As embodied herein and as claimed below, the present application is generally directed to an apparatus and method for determining a signal-to-noise (SNR) value from a readback signal.

In accordance with some preferred embodiments, the method generally comprises obtaining a readback signal (such as 144, 212, 226, 240) using a receiver (such as 112) coupled to a data recovery channel (such as 120) comprising a variable gain amplifier, VGA (such as 128) and a threshold detector, TD (such as 130). (See steps 220 and 234).

Errors are detected in the readback signal using an error detection threshold from the TD (such as 228) while applying a selected VGA gain to the readback signal from the VGA (such as 216, 242). (See steps 222, 224, 236, 238). A signal-to-noise ratio (SNR) value is thereafter determined for the readback signal in relation to at least a magnitude of the error detection threshold (such as step 246).

The method preferably uses a linear regression model (such as equations (2)-(4)) to determine the SNR value. The determined SNR value is further preferably compared to an SNR pass/fail threshold (such as equation (1)).

The receiver, the recording medium, the VGA and the TD are preferably incorporated into a data storage device (such as 100) and the receiver is preferably characterized as a magneto-resistive head. The readback signal is preferably obtained from a previously written oscillating pattern (such as 204).

In other preferred embodiments, the method is generally directed to determining a signal-to-noise ratio (SNR) value for a data storage device (such as 100) comprising a receiver (such as 112) adjacent a recording medium (such as 108) and a data channel (such as 120) comprising a variable gain amplifier (VGA, such as 128) and a threshold detector (TD, such as 130). The method includes using the receiver to obtain a readback signal from the recording medium (such as step 220, 234), applying a selected VGA gain value to the readback signal from the VGA while accumulating errors in the readback signal in relation to an error detection threshold from the TD (such as 222, 224, 236 and 238), and determining the SNR value in relation to at least a magnitude of the error detection threshold (such as 246).

As before, the determining step preferably comprises using a linear regression model to determine the SNR value in relation to at least the magnitude of the error detection threshold (such as equations (2)-(4). The SNR value is preferably compared to an SNR pass/fail threshold (such as equation (1)).

In other preferred embodiments, a data storage device (such as 100) is provided which comprises a receiver (such as 112) adjacent a recording medium (such as 108), a data recovery channel (such as 120) coupled to the receiver and comprising a variable gain amplifier (VGA, such as 128) which applies a selectable gain to a readback signal obtained by the receiver, and a threshold detector (TD, such as 130) which applies a selectable error detection threshold to detect errors in said signal. A controller (such as 142) coupled to the data channel selectively adjusts the gain of the VGA and the error detection threshold of the TD to determine a signal-to-noise ratio (SNR) value from the readback signal.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the housing without departing from the spirit and scope of the present invention.

In addition, although the embodiments described herein are directed to the determination of a device level SNR value for a data storage device, it will be appreciated by those skilled in the art that the claimed subject matter is not so limited and various other applications can be utilized, such as data transmission systems wherein data are transmitted through a medium to a remote receiver and optical data storage systems where data are transduced optically, without departing from the spirit and scope of the claimed invention.

1. A method comprising:
obtaining a readback signal using a receiver coupled to a data recovery channel comprising a variable gain amplifier (VGA) and a threshold detector (TD);
detecting errors in the readback signal using an error detection threshold from the TD while applying a selected VGA gain to the readback signal from the VGA; and
determining a signal-to-noise ratio (SNR) value for the readback signal in relation to at least a magnitude of the error detection threshold.

2. The method of claim 1, wherein the determining step further determines the SNR value in relation to a magnitude of the selected VGA gain.

3. The method of claim 1, wherein the selected VGA gain is characterized as a first gain, and wherein the determining step further determines the SNR value in relation to a magnitude of a second VGA gain applied by the VGA.

4. The method of claim 1, further comprising a step of obtaining a linear regression model, and wherein the determining step uses the linear regression model to determine the SNR value.

5. The method of claim 1, further comprising comparing the SNR to an SNR pass/fail threshold.

6. The method of claim 1, wherein the receiver, the VGA and the TD are incorporated into a data storage device.

7. The method of claim 1, wherein the determining step comprises:
adapting the gain of the VGA to a first value in relation to signal amplitude of the readback signal; and
adjusting the error detection threshold to a final value in relation to detection of a selected number of errors in the readback signal.

8. The method of claim 6, further comprising reducing the gain of the VGA from the first value to a lower, second value in relation to detection of a selected number of errors in the readback signal using the final value of the error detection threshold obtained during the adjusting step.

9. The method of claim 1, wherein the receiver is characterized as a magneto-resistive data transducing head.

10. The method of claim 1, further comprising a prior step of writing an oscillating pattern to a recording medium, wherein the readback signal of the using step is transduced from said pattern.

11. A method for determining a signal-to-noise ratio (SNR) value for a data storage device comprising a receiver adjacent a recording medium and a data recovery channel comprising a variable gain amplifier (VGA) and a threshold detector (TD), the method comprising:
using the receiver to obtain a readback signal from the recording medium;
applying a selected VGA gain value to the readback signal from the VGA while accumulating errors in the readback signal in relation to an error detection threshold from the TD; and
determining the SNR value in relation to at least a magnitude of the error detection threshold.

12. The method of claim 11, wherein the determining step further determines the SNR value in relation to a magnitude of the selected VGA gain value.

13. The method of claim 11, wherein the selected VGA gain value is characterized as a first gain value, and wherein the applying step further comprises reducing the VGA gain value to a second gain value while accumulating said errors in relation to said error detection threshold.

14. The method of claim 11, wherein the determining step comprises using a linear regression model to determine the SNR value in relation to at least the magnitude of the error detection threshold.

15. The method of claim 11, further comprising comparing the SNR to an SNR pass/fail threshold.

16. The method of claim 11, wherein the receiver is characterized as a magneto-resistive data transducing head.

17. The method of claim 11, further comprising a prior step of writing an oscillating pattern to the recording medium, wherein the readback signal of the using step is transduced from said pattern.

18. A data storage device comprising:
a receiver adjacent a recording medium;
a data recovery channel coupled to the receiver and comprising a variable gain amplifier (VGA) which applies a selectable gain to a readback signal obtained by the receiver, and a threshold detector (TD) which applies a selectable error detection threshold to detect errors in said signal; and
a controller coupled to the data channel which selectively adjusts the gain of the VGA and the error detection threshold of the TD to determine a signal-to-noise ratio (SNR) value from the readback signal.

19. The data storage device of claim 19, wherein the controller determines the SNR value and outputs said value to a host device.

20. The data storage device of claim 19, wherein the controller uses a linear regression model to determine the SNR value.
